(19) United States
(12) Patent Application Publication
(10) Pub. No.: US 2023/0334382 A1
(43) Pub. Date: Oct. 19, 2023

(54) NFT AND BLOCKCHAIN TICKETING PROCESSES AND PRODUCTS THEREBY

(71) Applicant: N.S.E., LLC, Santa Ana, CA (US)

(72) Inventors: Kaveh Newmen, Irvine, CA (US); Mizuki Asakura, Irvine, CA (US); Max T. Gluck, Laguna Niguel, CA (US)

(73) Assignee: N.S.E., LLC, Santa Ana, CA (US)

(21) Appl. No.: 18/299,999

(22) Filed: Apr. 13, 2023

Related U.S. Application Data
(60) Provisional application No. 63/331,811, filed on Apr. 16, 2022.

(51) Int. Cl. G06Q 10/02; G06Q 20/38

(52) U.S. Cl. CPC G06Q 10/02; G06Q 20/389; G06Q 20/3672

(57) ABSTRACT

Novel enhanced secure electronic records systems use Blockchain and NFTs to show improved access, and better ticketing outcomes without traditional middlemen. Subject technology as offered for consideration enables instant live verification at events, helping to prevent fraud while decentralized ticketing experiences away from current sources for the benefit of consumers, improving the electronic standards of care for event providers.

### CROSS-REFERENCE TO RELATED APPLICATIONS

The present application claims the benefit of U.S. Provisional Application No. 63/331,811, filed Apr. 16, 2022.

### CROSS-REFERENCE TO RELATED CONTRIBUTIONS

The present disclosure comprises nothing supported by grant funding, nor any related assistance of any government agency.

### BACKGROUND OF THE INVENTIONS

The present inventions address numerous challenges associated with conventional ticketing systems, including legal obstacles, credibility concerns, and trustworthiness issues surrounding ticket resale. These inventions introduce novel methodologies, systems, processes, and products that leverage the power of blockchain technology and non-fungible tokens (NFTs) to provide real-time verification at events, a capability not previously achieved. The innovations presented herein are directed towards enhanced transparency, reliability, and accessibility of verified ticketing data through the seamless integration of NFTs and blockchain technology. In particular, the present inventions focus on the effective management of crucial ticketing data using NFTs, which can significantly improve consumer outcomes and elevate the standard of care in ticketing services. By utilizing blockchain technology, the inventions enable secure and streamlined access to NFT ticketing data, promoting a higher level of confidence in ticket transactions. Furthermore, the combination of blockchain and NFT technologies facilitates live verification at various events, including movies, sporting events, and shows, as described herein. This approach empowers individuals to resell their tickets without reliance on traditional intermediaries, fostering a more equitable and efficient ticketing ecosystem.

### OBJECTS AND SUMMARY OF THE INVENTIONS

The present inventions introduce novel, secure blockchain ticketing systems that encompass the utilization of NFTs to offer improved access, enhanced commercial outcomes, and secure, decentralized access to consumers. These systems prevent fraud and streamline the ticketing experience by moving away from traditional providers. By improving event admission through proper NFT management and control, these inventions elevate the standard of care in the ticketing industry.

Embodiments include Blockchain Ticketing Systems featuring distributed cryptographic ledgers or related blockchain mechanisms with unique and proprietary algorithmic elements for prioritizing and forwarding. These systems act as a platform-as-a-service connecting users globally through privately decentralized databases, providing advantages such as interoperability, security, verification, records availability, and identity management.

Embodiments utilize blockchain mechanisms to enable seamless, real-time, and co-exclusive user access to ticketing data worldwide, contributing to progress in science and the useful arts, and enhancing the overall ticketing experience.

Embodiments provide a blockchain-based decentralized database, facilitating transparent exchange, analysis, and access to ticketing data, including NFT-based tickets and traditional tickets.

Embodiments enable seamless access to blockchain ticketing information through a decentralized framework, leading to improved consumer outcomes and a more equitable ticketing ecosystem.

Embodiments feature a blockchain ticketing system that supports both NFT-based tickets and traditional tickets, providing users with a range of ticketing options. This system offers a variety of applications, such as authentication of products and services, real estate, medical records, intellectual property records, supply chain data, gaming industry data, cryptocurrency, and other applications known to skilled artisans.

Embodiments provide a process for ticketing using blockchain technology, leveraging both NFT-based and traditional tickets, while utilizing the inherent security, transparency, and traceability features of blockchain systems.

Embodiments feature systems and processes using blockchain technology for instant verification at events, preventing fraud, decentralizing the ticket experience, and enabling ticket resale on the blockchain platform.

Embodiments include a novel enhanced system with a unique and proprietary smart contract for ticketing, wallet address, and verification of the wallet address for ticket authenticity, whether it be NFT-based or traditional tickets. NOTE—a source of origin via at least about 20-35 alphanumeric and the subset of (hexadecimal) characters exist for blockchain code.

### BRIEF DESCRIPTION OF THE DRAWINGS

Embodiments developed by the inventors comprise proprietary combinations of ticketing systems and blockchains, as understood by those skilled in the art, pursuant to the Appendices to this Specification.

FIG. 1 is a generalized schematic showing a cartooned blockchain type of schema as discussed for medical imaging data which has now been improved by the blockchain;

FIG. 2 is a centralized approach and contrasted with the present inventions; and,

FIG. 3 is a decentralized approach and claimed as best applied to the teachings of the present inventions for NFT data and blockchain mechanisms.

FIG. 4 is a cartooned schematic illustration of an exemplary NFT, being a tangible manifestation of that which artisans readily understand to be a representative image inherent in which all aspects of an NFT known and later developed may be housed. In FIG. 4, Non-fungible tokens (NFTs or NFT) as defined herein are self-authenticating digital certificates of unique assets, defined as a word of the year in 2021, with aligned and alignable interests in live events, social and cultural experiences, and philanthropy. Herein, an NFT is at least an Ethereum blockchain digital entity, verifiable in uniquity on the instant systems. Meaning, for the purpose of this patent application set, it means that a non-fungible token (NFT) is an exclusionary embodiment for any other terms, concepts and equivalents, such as “network file transfer,” or any other misnomeric or technically semantically or grammatically distinct malapropisms.

FIG. 5 shows schematically, in a cartooned fashion, use of the Blockchain and NFT for instant (live) verification at events, wherein the subject verification protocol is used to verify the NFT of an event attendee, exchanged on the Blockchain, according to the present inventions.

FIG. 6 summarizes schematically all existing ticketing models, showing the pitfalls and deficits among the prior art solved with the advent of the instant teachings.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary, and that the actual parameters, dimensions, materials, and/or configurations will depend upon the specific application or applications for which the teachings of the present disclosure is/are used.

### DETAILED DESCRIPTION OF THE INVENTIONS

The present inventor has identified unique opportunities to use Blockchain and NFT related secured data transmission means for optimization of the usage of inherent NFT data without compromising user privacy and safety/efficacy issues. As discussed throughout, and proven by evidence from the Appendix, it is respectfully submitted that novel teachings are offered for consideration herein, and claimed below, whereby global networks can be leveraged to upgrade the standard of care in terms of NFT and Blockchain data. NFT herein means at least a unique digital certificate, comprising a tranche of digital data registered in a blockchain, which inherently records to whom a piece of digital work belongs to by an electronic means within the token. Plethoric suggestions regarding NFT characteristics and data have yet to frame and address the objects of the instant teachings, it is respectfully proposed.

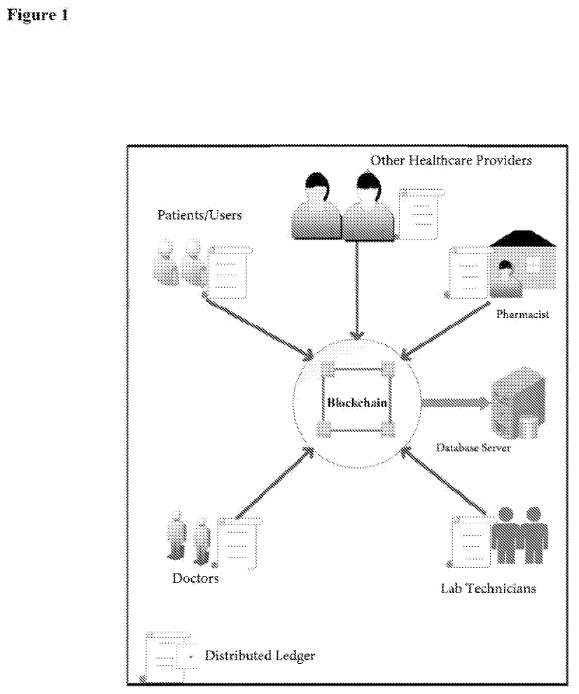

The medical imaging data example offered for consideration in FIG. 1 is demonstrative of how the blockchain enables data flow in ways that likewise drive ticketing and lifestyle improvements which are inherently onboarded by the use of the NFT mechanism. Prior to the present invention, the ticket itself was the largest impediment. Since the NFT approach obviates said issue, a cursory review of this prior art example makes the novelty and non-obviousness of the present invention more easily grasped, it is respectfully proposed. In order to have emergency/triage, as well as quotidien access to medical imagery data, the concept of moving from a centralized to a decentralized ledger was key. Traditional ticketing (such as that shown in representative state of the art example U.S. Pat. No. 10,937,251 (from the Appendix of this filing) and incorporated by reference herein, but fully distinguished by NFT/Blockchain addition of the present invention spent most of its powder on the need to “suitable for providing entry to an event,” which is how the NFT aspect distinguishes the instant approach from medical imaging data. The figure shows how the blockchain enables seamless transfer from all parties, yet the document icon next to the array of doctors and other healthcare providers, pharmacies, lab technicians, doctors and the patient to a distributed ledger. The distributed ledger functions as the black box because it was the highest impediment to actuation of the system.

Referring now to FIGS. 1-5, for the blockchain, by way of example only, and to FIG. 4 showing a cartooned NFT, simple examples offer an overview of the present inventions shown merely for illustrative, not limiting, purposes.

FIG. 1 shows the issues which are pitfalls among current paradigms and how Blockchain (and/or “blockchain,” as used interchangeably) defined herein as a structure comprising an ordered sequence of batched entries or blocks, with cryptographic hashes of immediate prior records in each block, are addressed according to the present inventions.

FIG. 2 shows how current approaches have not used NFT and event attendee data to be shared in a decentralized fashion, among the examples incorporated expressly by reference, in the instant appendix, inter alfa, are shown closest prior art developed. It is respectfully proposed that EFT and Blockchain data are arrayed ostensively susceptible to the Blockchain framework. In other words, by using the centralized ledger concept, it is respectfully proposed, current ticket approaches, electronic being the easiest example, necessarily focus upon fraud prevention, and by doing so, place consumers at risk, can charge premiums not related to the actual access, and as opposed to the present invention, wrest control from the consumer/end user. The Tixserve, Ltd., patent '251 which may be used to represent the TicketMaster/Live Nation brands of approach creates too many middlemen on the way to getting people into events. To overcome these issues, according to the present invention, the inventors have created a verification protocol driven by the use of NFTs. This replaces the steps of scanning a QR code for a smart wallet (adding two more middlemen in electronic model and driving up cost, of course) as show in these first two figures.

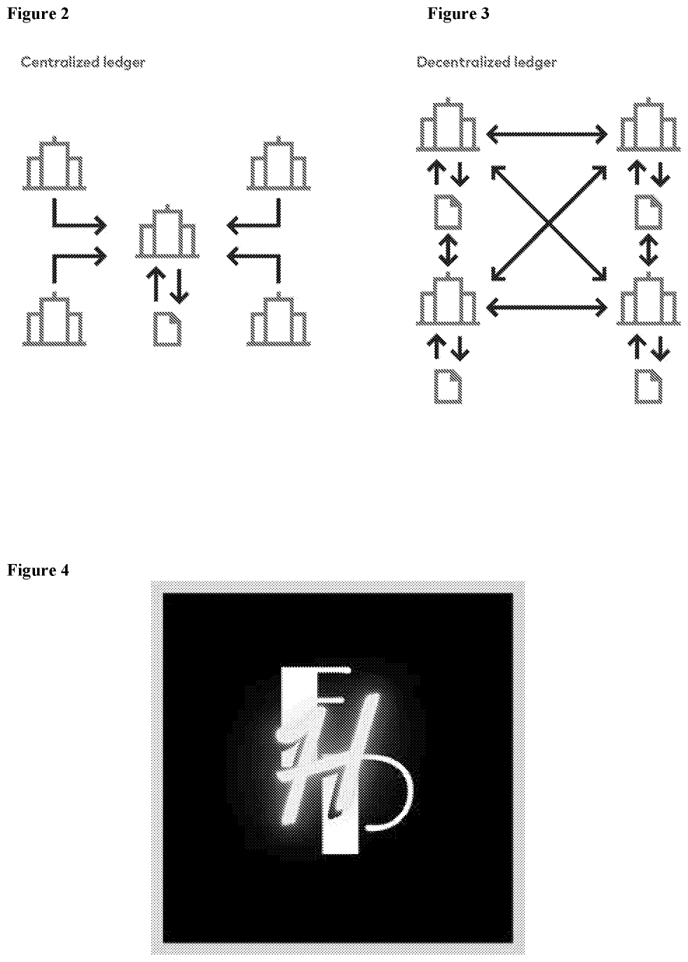

FIG. 3, once again for illustrative not limiting purposes, offers for consideration the proposition that achievement of an NFT electronic records system based upon Blockchain technology not only satisfies longstanding needs, but also adduces numerous benefits further explained, illustrated, and detailed below. The decentralized approach is key to leveraging the strength and efficiency of blockchain to manage NFT data using the Blockchain in a commercially feasible, and safe and protected fashion. In order to re-align the ticketing marketplace, and empower the end consumer, a step change is respectfully proposed. As claimed below and developed by the present inventors, NFTs shift the paradigm by designing around the concept of the middleman (not used as sexist or ethnocentrically targeted—rather a descriptive term for intermediaries who profit/benefit from the existing format herein obviated) using the NFT approach, as heretofore uncontemplated. Referring to the Figures still, a decentralized ledger becomes possible when the NFT, governed by rules known or soon to be known to artisans, allows the essential data to be subject to NFT verification protocols, and thus enables the NFT holder to freely exchange without further marketplace impediments, as shown and claimed below. The Appendix likewise uses the Friends in High Places™ framework to show that choosing to combine blockchain with NFT platforms delimits consumer choices by providing ingress/entry and those other VIP pass types of benefits which consumers desire to acquire, absent the massive middleman costs and limits on transfer.

FIG. 4 shows an illustrative and not limiting example of an NFT, as those skilled in the art will understand to embody said tangible manifestations described herein and covered by the subset of inventions here disclosed, namely, both the ticketing-means and processes for using NFTs and the Blockchain, as first denoued herein.

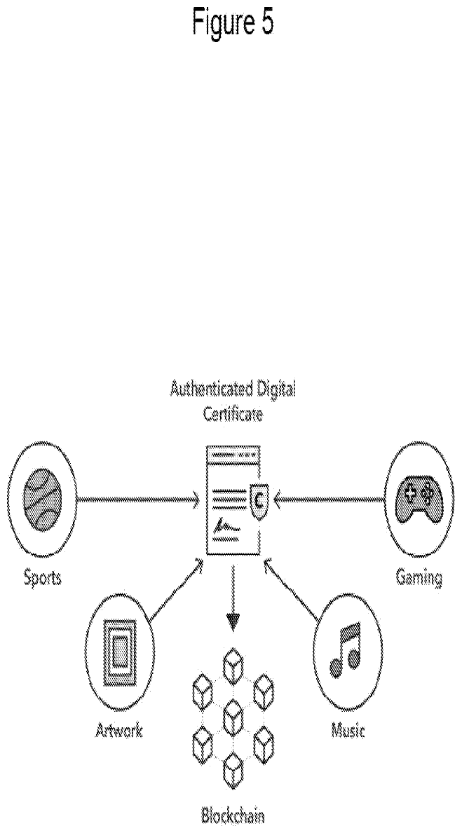

FIG. 5 schematizes how NFTs, as a unique data set, are stored and tracked according to the present invention, namely any event (examples being sports, artwork, gaming and music) utilizing NFTs can gate any event based on at least said themes by using the NFT to verify event entry, and other benefits and privileges of said NFT, which is shared via Blockchain, as shown.

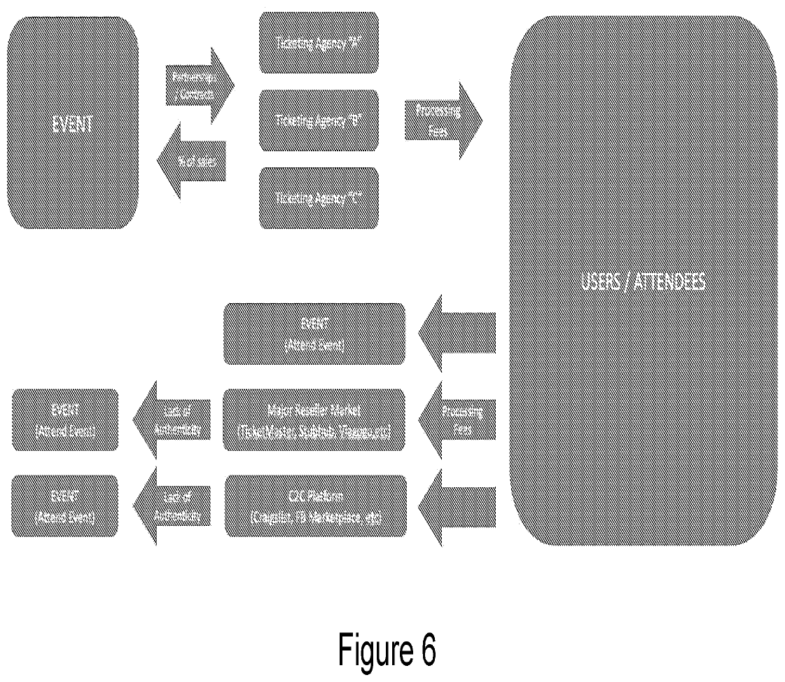

FIG. 6 offers a comprehensive summary of the conventional, meaning prior art, ticketing mechanisms existing to date. Events today are served by these models from LIVE NATION to TixServe (per U.S. Pat. No. 10,937,251 further discussed herein) where each event requires partnerships, purchases and one of three existing paths for resale in order for consumers to attend the events. It is noteworthy that each of said models is subject to drawbacks and pitfalls (from loss of tickets, to fraud, to multiple middlemen) which are addressed by and overcome with the teachings of the present invention whereby storage occurs on blockchain (not phone hardware), smart wallets and websites at the events (for example).

According to the present inventions, a platform-as-service approach allows connections to be facilitated and enabled using a primality decentralized NFT and Blockchain database. The following U.S. Letters Patents are expressly incorporated as if reproduced herein in their entirety: 11,232,439; 11,206,138; 10,937,251; 10,540,654; and, 10,025,797, each of which describes prior art prior art ticketing as distinguished by FIG. 6 of the instant teachings.

Those skilled in the art understand that empowerment of users means that no matter which of the other 2,000 unique chains available to the world are now used, the instant teachings are driven by NFTs having smart contracts written into code with a wallet address showing the origin of the smart contract (at least about 26-35 characters, meaning as defined herein—a source of origin via at least about 20-35 alphanumeric and the subset of (hexadecimal) characters exist for blockchain code, which by verification of the wallet address of the originating contract users are able to confirm that each said given NFT originates from a specific source, thus verifying authenticity.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment,” means that a particular feature, structure, or characteristic described in connection with the embodiment is included in at least one embodiment. Thus, appearances of the phrases “in one embodiment”, or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Specific embodiments disclosed herein may be further limited in the claims using, consisting of, or consisting essentially of language. When used in the claims, whether as filed or added per amendment, the transition term “consisting of” excludes any element, step, or ingredient not specified in the claims. The transition term “consisting of” essentially limits the scope of a claim to the specified materials or steps and those that do not materially affect the basic and novel characteristic(s). Embodiments of the invention so claimed are inherently or expressly described and enabled herein.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. An NFT ticketing-means, effective to provide entry to at least an event; which comprises, in combination:
at least a data file, audio file, or image viewable file, arrayed and/or stored on at least one of a mobile user device or other special purpose computing systems (including smart devices being any devices like Ledger, apple watches, other tech pieces which are effective to and designed to work with crypto-currency);
said NFT ticketing-means having a plurality of other uses, further comprising: authenticating of products, services, and chimeric hybrids of the same; real estate; medical records; intellectual property records and data; supply chain data; gaming industry data; cryptocurrency; and plethoric other applications, known to artisans;
and, at least a Blockchain secured electronic records platform being objectively verifiable and replicable showing both feasibility and scalability relative to the improved NFT ticketing-means and system which is able to verify the NFT's existence on the blockchain.

2. A process for ticketing using NFTs, which comprises, in combination, at least the steps of:
providing at least an NFT, having all inherent characteristics, value-holding properties and electronic transferability and hypothecation aspects and data incorporated therein; leveraging a Blockchain system for authentically and replicably linking, arraying, and presenting data sets, in a decentralized fashion, to offer for consideration said at least an NFT for ticketing purposes; and, activating at least a ticketing event, thereby including acceptance of the at least an NFT as a ticket.

3. The process of claim 2, wherein systems and processes using Blockchain and NFTs for instantaneous verification live at events, as defined and described herein, which extenuates, mitigates, and helps prevent fraud while decentralizing the ticket experience away from current providers and enabling people to resell their tickets on the Blockchain and enable lending or the ability to lease out a ticket , for example for season ticket holders who want to sell individual tickets; concert season ticket holders, on any platform/blockchain/technology platform.

4. The process of claim 3, further comprising sporting events, movie theaters, e-sports tournaments, online gaming events , metaverse/virtual reality type events, shows and any live or performance events, for which the process for using NFT's ticketing adds a commercial advantage or user access benefits based upon the blockchain or crypto-technology compatibility.

5. The process of claim 4, using an accepted and effective verification protocol to verify the NFT of an event attendee, and wherein the NFT's are activating a ticketing event being used IRL, such as offered for consideration by TOKENPROOF.

6. The process of claim 5, further comprising:
sub-elements and products thereby wherein the extant process of scanning a QR code for a smart wallet and RFID wristband are replaced by the use of Blockchain and NFT platforms, including commercial and user benefits of positively impacting by reducing fraud, impacting the potential for fraud, and decentralizing the ticketing experience.

7. The process of claim 6, and products thereby:
whereby using Blockchain and NFT for instant /live verification whereby
event organizers are incentivized to enable people to resell and/or lease/loan/lend) their respective tickets using the process, whereby the NFT on-boards other access and privilege aspects inherent in the NFT as Blockchain verified.

8. The process of claim 7, driven by Blockchain/NFT mechanisms disclosed herein and
defined by for example, Friends in High Places™ protocols, further comprising overall NFT Verification by means of assigning ownership and corroborating authenticity of each said unique digital token/NFT transferred to a consumer and offered for consideration to a vendor.

9. The process of claim 8, said Blockchain/NFT ticketing methods wherein acquisition of at least an NFT creates levels different tiers of access/ingress, from basic to VIP, each level of ingress into events and collateral benefits acquired by consumers along with each said NFT, based upon the access/ingress tier.

10. The process of claim 9, for gating ingress to an event for multiple consumers, which comprises, in combination: providing NFT's having different levels offered for consideration by a replicably corroborable source for the NFT's; said NFT's being in and of themselves dynamic entry codes, hypothecated to consumers with a transparent schema for valuation; presenting each said NFT acquired by a consumer directly to a digital or physical venue wherein entry is therefore permitted.

11. The process of claim 10, wherein each said NFT is recognized by the Blockchain.

12. The process of claim 11, wherein said blockchain or analogous means allows for the transfer of NFT's from consumer to consumer or minting of soul-bound possession of subject NFT's to a consumer, once acquired.

13. The process of claim 12, wherein conventional smart devices and later developed
special purpose electronic means display each said NFT or convey the metadata contained within aforementioned NFT acquired by a consumer.

14. An improved VIP ticketing or membership pass system, comprising, in combination: at least an NFT (non-fungible token) and an NFT validation system

15. The system of claim 14, said at least an NFT being priced and distributed on at least one Blockchain selected from the group of Ethereum and any other Blockchain.

16. The system of claim 15, further comprising proprietary algorithms for at least an NFT verification protocol and membership allocation.

17. The system of claim 16, wherein said NFT driven benefits include, but are not limited to: VIP Festival Access; private and quasi-private NFT-level holders benefits; and, private and quasi-private dining, flying, and related lifestyle experiences further comprising: each of the use cases of NFTs currently available and potentially available in future events.

18. The system of claim 17, further comprising: all required elements to drive a first truly global NFT project likewise functioning as a private or quasi-private membership to an
exclusive community of consumers with aligned and alignable interests in live/digital events, social and cultural experiences, and philanthropy (meaning the ability to help people through information and techniques v. money)

19. The system as defined herein, and of claim 18, comprising, in combination: a unique and proprietary NFT as shown and described, further comprising a smart contract written into code; said smart contract having a wallet address indicating a source of origin via at least about 20-35 alphanumeric and a subset of (hexadecimal) characters; whereby verification of the wallet address of the originating contract enables users to confirm that each said respective NFT originates from a specific source, verifying authenticity of each said NFT.

20. An improved method for NFT verification, comprising: providing a user with a generated NFT created by a smart contract written into code; said smart contract comprises a wallet address indicating a source of origin, denoted by an alphanumeric and/or hexadecimal string of between approximately 20 and 35 characters; confirming a respective source of origin of the generated NFT; and, therefore—authenticating the generated NFT. blockchain

21. The improved method of claim 20, consisting essentially of at least one blockchain
from the group of more than 2000 unique chains existing; whereby NFTs are created and function therein, including future developed products and established public standards.

22. The improved method of claim 21, wherein the NFT's are created in various types of blockchains, including but not limited to Ethereum Blockchain and comprise the ERC-721 Ethereum smart contract, ERC-1155 smart contract, or any similar token standards as applicable.

23. The improved method of claim 22, further comprising: validating ownership of NFTs, comprising: selecting at least one blockchain from the group of Bitcoin, Ethereum and others available to the public; generating an NFT having at least been coded into at least a smart contract; the at least a smart contract having a wallet address being a string of at least about 20 characters, and as many as 35; validating ownership by verification of the smart wallet address of the originating Contract; whereby users are able to confirm that any given NFT originated from a specific source; thus, verifying authenticity.
